(19) United States
(12) Patent Application Publication
(10) Pub. No.: US 2011/0030890 A1
(43) Pub. Date: Feb. 10, 2011

(54) LABELLING MACHINE

(75) Inventor: Michael Arthur Cumberland, Norwich (GB)

Correspondence Address: BURR & BROWN, PO BOX 7068, SYRACUSE, NY, 13261-7068, US

(73) Assignee: NOBAC Limited, Bury St. Edmunds (GB)

(21) Appl. No.: 12/811,967

(22) PCT Filed: Jan. 15, 2009
(86) PCT No.: PCT/GB09/00098

§ 371 Date: Sep. 29, 2010

(30) Foreign Application Priority Data
Jan. 15, 2008 (GB) 0800644.7

(51) Int. Cl. B32B 37/00

(52) U.S. Cl. 156/249; 156/538

(57) ABSTRACT

A labelling machine applying labels (16) from a continuous web (10) to packages moving on a conveyor (70) past a label application station. The labels (16) are printed on the web (10) with their long edges at right angles to the length of the web, i.e. the long edges of the labels lead as the web is fed from the web towards the label application station (34). At the point where the leading label is separated from the web, the direction of movement of the label is changed so that the narrow edge of the label leads as the label moves from the separation point to the application station.

### FIELD OF THE INVENTION

This invention relates to labelling, in particular applying self-adhesive (pressure sensitive) labels to packages. Typically the packages will be foodstuffs packages (solid and/or liquid). The invention relates to a machine for applying such labels, and to labels supplied in roll form.

### BACKGROUND TO THE INVENTION

Labelling machines typically are fed with labels from a continuous roll of labels which will have been printed at a remote location. The roll of labels will be loaded in the labelling machine. The packages to be labelled will travel on a conveyor through the labelling machine and as they pass a label application station, a label will be detached from the roll and applied to the package.

The roll of labels can be provided on a backing liner from which they are separated as they are applied to a package, or the roll can be of “linerless” labels where the adhesive on the back of the labels is in alignment with a transparent silicone or other release layer printed on the front of the labels.

This invention is particularly applicable to labels which have a first dimension which is greater than a second dimension at right angles to the first dimension. For example, such labels may be rectangular with length greater than the width.

It is conventional for a label to be fed (at the label application station) so that the narrow edge of the label is the first to make contact with the package, and as the package moves past the label application station, the leading edge of the label adheres to the package and as the package moves forward, the rest of the label is drawn from the label feed mechanism and pressed against the package surface so that the label is applied to the package as the package moves through the label application stage. As a result of this process, the labels have to be fed “narrow edge first” and a consequence of this is that the roll of printed labels is narrow in width. Because the long dimension of the label runs along the length of the roll, the roll is relatively large in diameter.

It is an aim of the present invention to overcome at least one problem associated with the prior art whether referred to herein or otherwise.

### SUMMARY OF THE INVENTION

According to a first aspect of the present invention, there is provided a machine for applying labels, the machine comprising means for supporting a reel of web-based labels, first transport means for transporting the labels as part of the web in a first transport direction to a separating station where the leading label is separated from the web, and second transport means for transporting the separated label in a second transport direction at right angles to the first transport direction to a label application station.

The second transport means preferably includes a belt to which the adhesive of the label can be lightly tacked to hold the label while it moves in the second transport direction.

Preferably the reel of web-based labels comprises a roll of self-adhesive labels in the form of a continuous web, wherein each label has a major and a minor dimension, and the major dimension of the labels extends across the width of the roll.

The labels may be rectangular in form with the wide edge of each label leading as the web is drawn off from the roll.

Preferably the labels are “linerless” labels.

Preferably the labels comprise printed information thereon. Preferably the information is arranged to be orientated across the rectangular label may extend from a first lateral side (with a minor dimension) to a second lateral side (with a minor dimension),

Preferably the labels are initially fed and transported with the major dimension of the label leading (and with the minor dimension extending in the direction of transportation). Preferably the labels are delivered and/or applied to an article with the minor dimension of the label leading (and with the major dimension extending in the direction of transportation and/or application).

The labels may have a front edge, a rear edge and two side edges (lateral edges). Preferably the front and rear edges are of a greater length than the side edges. Preferably the front and rear edges extend across the roll of the labels. Preferably the front and rear edges extend across the web of labels. Preferably the side edges locate along the sides of the roll of labels. Preferably the side edges locate along the sides of the web of labels.

Preferably the roll of labels and/or the web of labels is of one label width.

The machine may comprise separating means in the form of a blade to separate the leading label from the web. The separating means may be located along the first transportation means.

Each label may comprise adhesive means provided on a first face and releasing means provided on a second face. Preferably the adhesive means may comprise one or more linear strips of adhesive means. Preferably the releasing means may comprise one or more linear strips of a releasing agent. Preferably the adhesive means is arranged to cooperate with the adhesive means when the labels are arranged in a roll. The releasing agent may comprise a silicone releasing agent.

According to a second aspect of the present invention, there is provided a method of applying labels to articles comprising supporting a reel of web-based labels, transporting the web of labels in a first direction by first transport means to a separating station, separating a leading label from the web, and transporting the separated label by second transport means in a second transport direction to a label application station, wherein the second transport direction is at a right angle to the first transport direction.

Preferably the method includes adhering the label to the second transport means. The method may comprise adhering the label by adhesive located on the label.

Preferably the reel of web-based labels comprises a roll of self-adhesive labels in the form of a continuous web, wherein each label has a major and a minor dimension, and the major dimension of the labels extends across the width of the roll.

The labels may be rectangular in form with the wide edge of each label leading as the web is drawn off from the roll.

Preferably the labels are “linerless” labels.

Preferably the method comprises feeding the labels and transporting the labels in the first direction with the major dimension of the label leading (and with the minor dimension extending in the direction of transportation). Preferably the method comprises are delivering and/or applying the labels to an article with the minor dimension of the label leading (and with the major dimension extending in the direction of transportation and/or application).

According to a third aspect of the present invention there is provided a roll of self-adhesive labels in the form of a continuous web, wherein each label has a major and a minor dimension, and the major dimension of the labels extends across the width of the roll.

The labels may be rectangular in form with the wide edge of each label leading as the web is drawn off from the roll.

Preferably the labels are “linerless” labels.

### BRIEF DESCRIPTION OF THE DRAWINGS

The invention will now be further described, by way of example, with reference to the accompanying drawings, in which:

FIG. 1 is a perspective view of a roll of linerless labels;

FIG. 2 is an edge view of the web of FIG. 1;

FIG. 3 is a schematic representation of a label transport path in a first embodiment of the invention;

FIG. 4 is a schematic representation of a label transport path in a second embodiment of the invention

FIG. 5 shows details of the label transfer station from FIG. 4; and

FIGS. 6a, 6b and 6c show, in cross-section, label transfer taking place.

### DESCRIPTION OF THE PREFERRED EMBODIMENTS

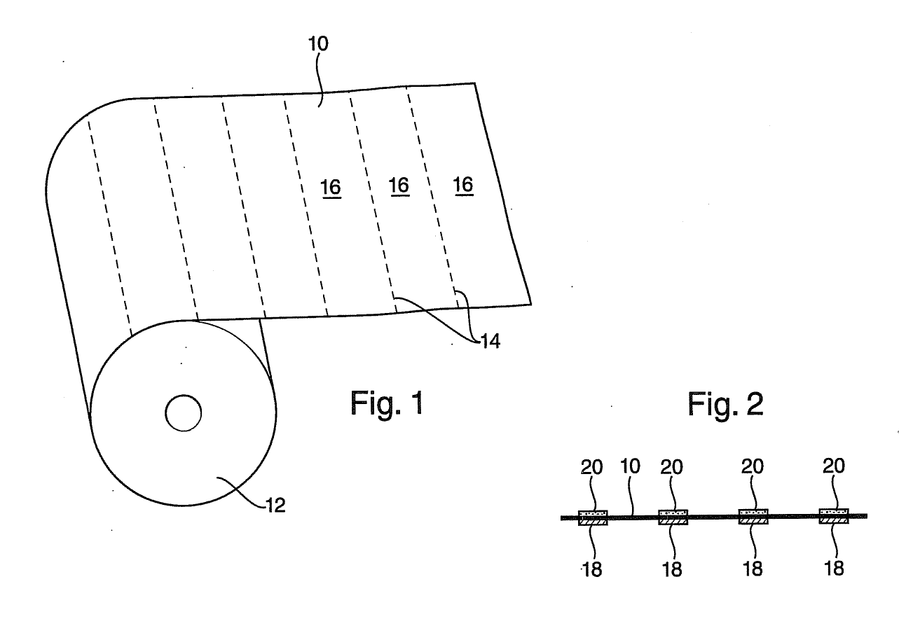

FIG. 1 shows one end of a web 10 which is wound on itself to form a roll 12. The web is printed on one or both sides with label information in a repeating way such that the web can be divided into individual labels to be applied to individual packages.

In FIG. 1, dotted lines 14 show where the web will be separated into individual labels. It will be seen therefore that each label 16 has a long dimension (which extends across the width of the roll 12) and a short dimension at right angles to this long dimension.

The web 10 shown in FIG. 1 is a web of linerless labels. The web is a single sheet which (in addition to the printed visual information) is “printed” on one side with strips of adhesive and on the other side with strips of silicone release agent. The release agent is transparent and is printed over the visual information and will not obscure any of that information. This is illustrated in FIG. 2 where the adhesive is shown at 18 and the silicone at 20. When the web is wound to form the roll 12, the adhesive 18 on the underside of the web will come into contact with the silicone on the top of the web, so that the web can be easily unrolled from the roll.

It is a characteristic of linerless labels that the web 10 will be a single continuous web and, just before label application, the web can be slit using a guillotine or the like to separate the leading label from the rest of the web. The invention is not however restricted to linerless labels, and the operation to be described in the following description would work equally well for labels mounted on a backing sheet where the labels would be detached from the backing sheet before application to a package, and the backing sheet would then be processed separately.

With the web 10 designed so that the long edge of each label leads, more labels can be provided on a roll of a given diameter, when compared with a roll of the same labels set up so that the narrow edge leads. Thus there would be less downtime caused by changing any empty roll for a full roll.

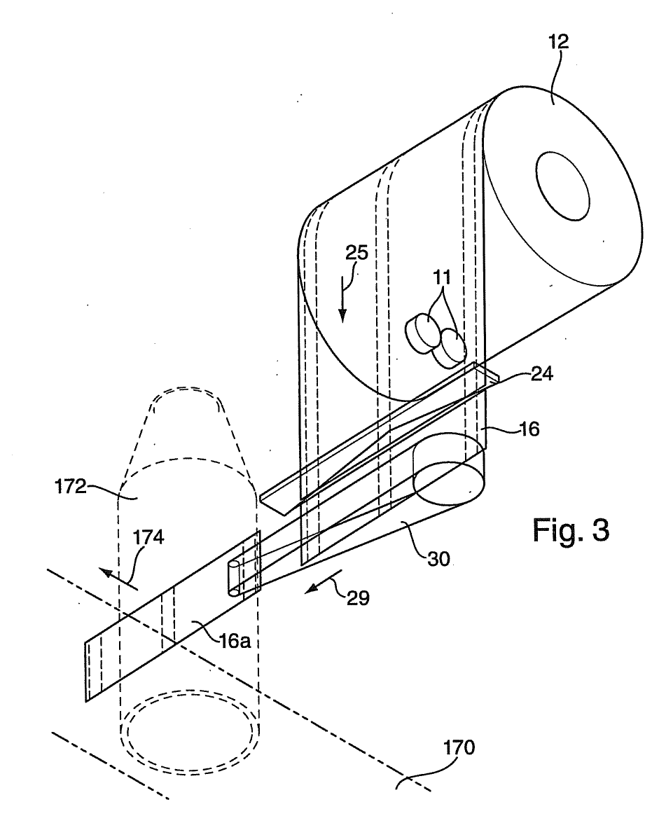

FIG. 3 shows an embodiment where the roll 12 is mounted on a horizontal axis and the web is drawn off the roll by rollers 111 in a downward direction as indicated by arrow 25. The web passes directly to a blade 24 where each label 16 is separated from the web. A separated label 16 is then picked up by a belt 30 through a light adhesion of the adhesive 18 to the surface of the belt 30 and transported, with the belt, in a horizontal direction 29 into the path of a bottle 172 moving in the direction of an arrow 174 and standing upright on a conveyor 170. In this Figure, the reader is looking upwards from a position below the conveyor 170. The leading end of the label 16a then attaches itself to the bottle 172 and as the bottle moves on, the label is drawn off from the belt 30 and swept around the surface of the bottle by suitable wipers so that the label ends up wrapped around the bottle.

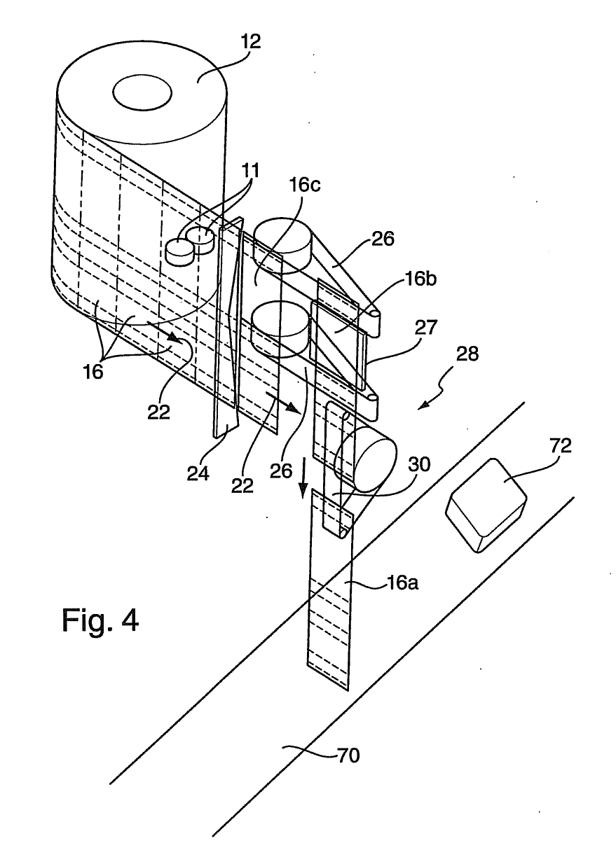

FIG. 4 shows an alternative embodiment where the roll 12 is mounted on a vertical axis and the web is fed from the roll, in a vertical plane, initially by rollers 11. The roll is advanced in a first direction indicated by arrows 22. Registration marks are printed on the back of the roll, one for each label. The registration marks are sensed by a sensor and trigger a cutting operation to separate the leading label from the web. The cutting takes place at a schematically shown guillotine blade 24 where the web is separated into individual labels. In FIG. 3, separated labels are shown at 16a, 16b and 16c.

In this embodiment, variable print information (for example pack weight) is applied to each label by a printing head located at label position 16b. At this position, a backing plate 27 supports the label as the print is applied.

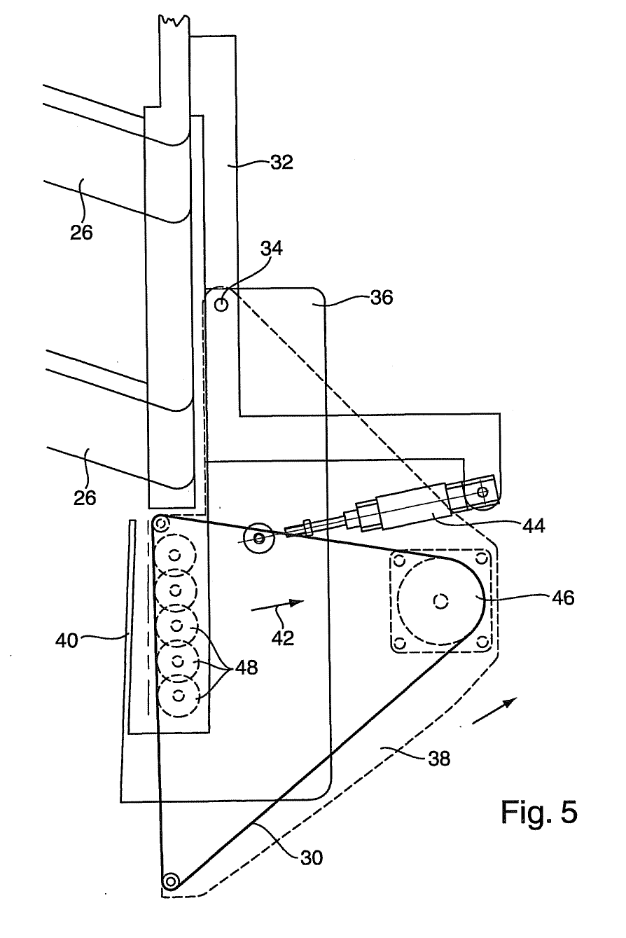

The labels are picked up by two cross transport belts 26 and conveyed to a transfer area 28 where they are transferred to a vertical transport belt 30. The transfer of the labels from the cross transport belts to the vertical transport belt will be described in more detail with reference to FIGS. 4 and 5.

FIG. 5 shows some of the structure at the transfer station 28. A frame 32 supports the end rollers of the transport belts 32 and has a pivot mounting 34 on which both a pressure plate 36 and a carrier plate 38 (shown in dotted lines) for the vertical transport belt 30 are mounted. The pressure plate has a pressure finger 40, and the plate can be moved in the direction indicated by the arrow 42, under the influence of an operating cylinder 44.

The carrier plate 38 also carries a driven pulley 46 which drives the belt 30, and a series of idler support rollers 48.

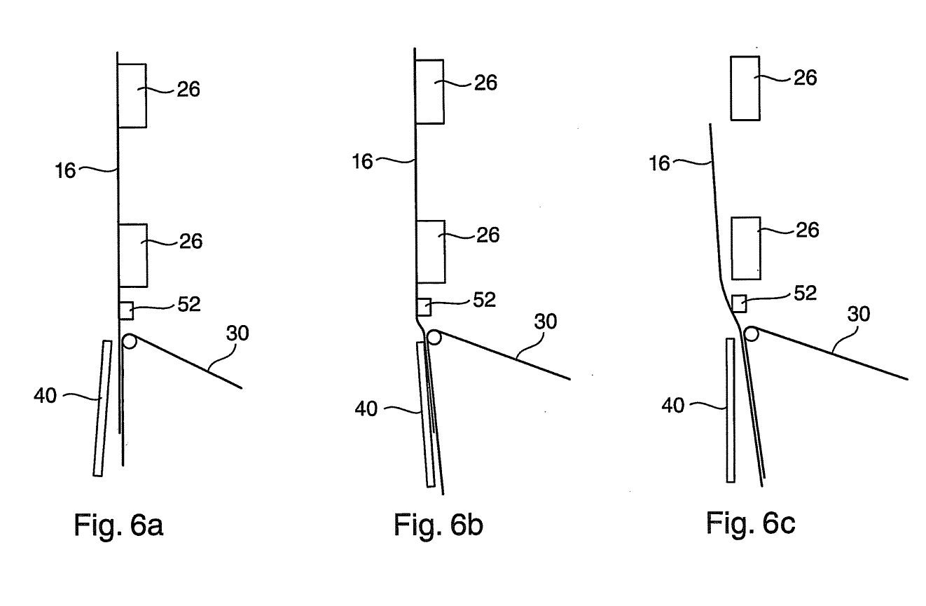

FIG. 6 show how a label 16 is transferred from the cross transport belts 26 to the vertical transport belt 30.

As each label moves to the right (as seen in FIG. 4), the bottom edge 50 of the label extends below the lower belt 26, and overlaps with the top of the vertical belt 30 by sufficient distance to ensure that the lowermost strip of adhesive 18 overlaps the belt. At this stage, the label is still adhered (with a light tack) to the belts 26 (FIG. 6a).

Next, the pressure plate 36 with its finger 40 is activated to be rotated anti-clockwise so that the top end of the finger 40 presses the bottom edge 50 of the label against the vertical belt 30. The belt on its carrier plate also swings about the pivot 34, and the label is pulled against a fixed bar 52. The effect of this movement is to produce a small force in the lower half of the label tending to detach the label from the lower belt 26 (FIG. 6b)

As the vertical belt 30 continues to rotate, so the label is wholly detached from the belts 26, and is moved downwards on the belt 30. The finger 40 moves back at this point (FIG. 6c)

The apparatus shown in FIGS. 4 and 5 is particularly suitable for applying so called C-labels which wrap around three sides, of a package. These labels are relatively long in length compared to their width. The invention is however equally suitable for labels which are entirely applied to one face of a package or even to wrap-around labels (eg bottles as in FIG. 3).

The material of the transport belts will be chosen to afford a light tack contact between the adhesive on the web and the belt material, without any significant amount of the adhesive remaining on the belt after the label has been detached.

1. A machine for applying labels, the machine comprising means for supporting a reel of web-based labels, first transport means for transporting the labels as part of the web in a first transport direction to a separating station where the leading label is separated from the web, and second transport means for transporting the separated label in a second transport direction at right angles to the first transport direction to a label application station.

2. A machine for applying labels according to claim 1 in which the second transport means includes a belt to which the adhesive of the label can be lightly tacked to hold the label while it moves in the second transport direction.

3. A machine for applying labels according to claim 1 in which the reel of web-based labels comprises a roll of self-adhesive labels in the form of a continuous web, wherein each label has a major and a minor dimension, and the major dimension of the labels extends across the width of the roll.

4. A machine for applying labels according to claim 3 in which the labels are rectangular in form with the wide edge of each label leading as the web is drawn off from the roll.

5. A machine for applying labels according to claim 1 in which the labels are “linerless” labels.

6. A machine for applying labels according to claim 1 in which the labels comprise printed information thereon and the information is arranged to be orientated across a rectangular label and the information extends from a first lateral side (with a minor dimension) to a second lateral side (with a minor dimension).

7. A machine for applying labels according to claim 3 in which the labels are initially fed and transported with the major dimension of the label leading (and with the minor dimension extending in the direction of transportation).

8. A machine for applying labels according to claim 3 in which the labels are delivered and/or applied to an article with the minor dimension of the label leading (and with the major dimension extending in the direction of transportation and/or application).

9. A machine for applying labels according to claim 1 in which the machine comprises separating means in the form of a blade to separate the leading label from the web.

10. A machine for applying labels according to claim 1 in which each label comprises adhesive means provided on a first face and releasing means provided on a second face.

11. A machine for applying labels according to claim 10 in which the adhesive means is arranged to cooperate with the adhesive means when the labels are arranged in a roll.

12. A method of applying labels to articles comprising supporting a reel of web-based labels, transporting the web of labels in a first direction by first transport means to a separating station, separating a leading label from the web, and transporting the separated label by second transport means in a second transport direction to a label application station, wherein the second transport direction is at a right angle to the first transport direction.

13. A method of applying labels to articles according to claim 12 in which the method includes adhering the label to the second transport means.

14. A method of applying labels to articles according to claim 13 in which the method comprises adhering the label by adhesive located on the label.

15. A method of applying labels to articles according to claim 12 in which the method comprises feeding the labels and transporting the labels in the first direction with a major dimension of the label leading (and with a minor dimension extending in the direction of transportation).

16. A method of applying labels to articles according to claim 12 in which the method comprises delivering and/or applying the labels to an article with a minor dimension of the label leading (and with a major dimension extending in the direction of transportation and/or application).

17-18. (canceled)
